(19) United States
(12) Patent Application Publication
(10) Pub. No.: US 2002/0146100 A1
(43) Pub. Date: Oct. 10, 2002

(54) Remote controlled hurricane shutter system

(76) Inventor: Eric Glenn Hanson, Miami Springs, FL (US)

Correspondence Address: ERIC HANSON, 17300 NW 68 AVENUE, #211, MIAMI LAKES, FL, 33015, US

(21) Appl. No.: 09/827,753

(22) Filed: Apr. 6, 2001

(51) Int. Cl. H04M 11/00

(52) U.S. Cl. 379/102.01

(57) ABSTRACT

The invention encompasses a remote controlled hurricane shutter system connected to a network through which a remote user can control the hurricane shutter system. The remote controlled hurricane shutter system contains a hurricane shutter system including a roll type hurricane shutter and a motor that deploys and retracts said shutter. A modem is connected to the network so as to receive a signal from the network. A microprocessor connected to the modem and the hurricane shutter system. When the microprocessor is signaled through the network, the hurricane shutter can be deployed or retracted. The remote controlled hurricane shutter can include a means for confirming deployment connected to said microprocessor and said hurricane shutter system.

### BACKGROUND OF THE INVENTION

1. Field of the Invention

The invention relates to hurricane and storm shutters. In particular, the invention relates to a remote controlled hurricane shutter system that allows for a user to deploy roll type hurricane shutters from a remote location. In addition, the system includes means to verify that the shutter has been successfully deployed.

2. Description of the Prior Art

Hurricanes and other intense windstorms cause significant property damage to houses. Often in these storms, the strong winds cause objects to become projectiles that have enough force to shatter windows. After, the window is shattered, dangerous winds and rain can enter the building causing costly damage.

Other problems that occur in these powerful storms are power outages and telephone outages. In almost any hurricane, electrical power is lost for extended periods of time starting before the storm even strikes. In contrast, telephone service is more durable and may be only briefly lost during storms.

To mitigate the damage of hurricanes and windstorms, many communities and insurance underwriters require hurricane shutters for protection of buildings. Hurricane shutters typically comprise resilient panels that are strong enough to resist projectiles and prevent them from shattering the underlying window.

Hurricane shutters of the prior art cannot protect the house if the user is not located at the house to deploy the shutters manually. For example, if a homeowner is out of town on vacation and a hurricane strikes, the user either must contact a friend or relative to deploy the shutters for them or return to a dangerous storm in order to deploy the shutters. In addition, vacationers often cannot deploy hurricane shutters as a precaution before leaving because the presence of shutters during clear weather may notify burglars that the homeowner is on vacation away from the home.

Many designs for shutters have been proposed. Some designs require the overlapping panels to be placed manually. In contrast, the roll type hurricane shutters often include a motor for power-assisted deployment of the shutters. Examples of roll type hurricane shutters are shown in the following Miller, U.S. Pat. Nos. 5,850,862; and Miller 5,575,322. These patents do not teach a system that can be deployed from a remote location.

Several patents discuss methods of controlling appliances from remote locations. These patents include the following: Ivie et al., U.S. Pat. No. 5,815,086; Bertieri et al., U.S. Pat. No. 5,782,032; and Mosebrook et al. U.S. Pat. No. 5,905,442. While these patents disclose methods and devices of controlling appliances from remote locations they are not suited for use under storm conditions. The cited prior art remote control systems are not able to verify the deployment of the shutters during power outages. The prior art do not include back-up systems to provide power in the case of a power outage. Even worse, the prior art remote controls may mislead users into believing that the shutters have deployed when they have not during occasions when the power is interrupted even though the telephone service remains working.

In light of the prior art, a need for a remote controlled hurricane shutter system is presented.

### SUMMARY OF THE INVENTION

The invention encompasses a remote controlled hurricane shutter system connected to a network through which a remote user can control the hurricane shutter system. The remote controlled hurricane shutter system contains a hurricane shutter system including a roll type hurricane shutter and a motor that deploys and retracts said shutter. A modem is connected to the network so as to receive a signal from the network. A microprocessor connects to the modem and the hurricane shutter system. When the remote user signals the microprocessor through the network, the hurricane shutter deploys or retracts.

The remote controlled hurricane shutter can include a means for confirming deployment connected to said microprocessor and said hurricane shutter system. The means for confirming deployment can be a back-up power supply such as a battery or generator. The back up power supply is connected to the microprocessor and the motor and supplies electrical power if electrical service is interrupted.

The means for confirming deployment can also be a power supply detector that indicates to the user that said remote controlled hurricane shutter is powered or not powered.

The means for confirming deployment also can include a shutter state detector that indicates to the microprocessor that said shutter is deployed or retracted. The shutter state detector can be used alone or in conjunction with other means. The shutter state detector includes a circuit connected to said microprocessor including a first contact in said shutter and a second contact in the window and said first contact and said second contact are positioned to touch each other when said shutter is deployed so that said circuit is completed when said shutter is deployed. If the remotely located user is notified that the shutter was not successfully deployed, the user can resort to alternate methods of deployment like contacting a friend or neighbor or by returning home.

The network to which the remote controlled hurricane shutter system is connected can be any suitable network. The telephone network is an example of a suitable network. The Internet is an alternative suitable network. In embodiments utilizing analog networks such as the telephone network, the modem connected to the network and microprocessor must include a digital to analog converter.

In accordance with these and other objects that will become apparent hereinafter, the instant invention will now be described with particular reference to the accompanying drawings.

### BRIEF DESCRIPTION OF THE DRAWINGS

FIG. 1 is schematic drawing of the system utilizing an analog modem showing the shutter in a retracted position.

FIG. 2 is a schematic drawing of the system utilizing the Internet showing the shutter in a deployed position.

FIG. 3 is a flow chart of the microprocessor logic.

### DETAILED DESCRIPTION OF THE PREFERRED EMBODIMENTS

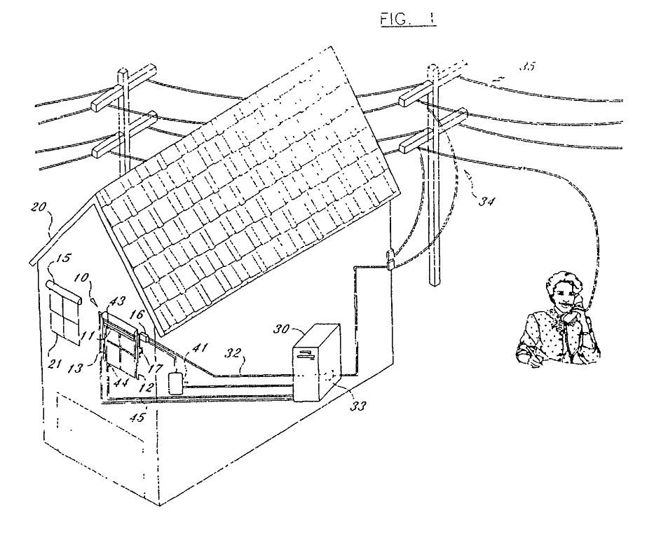

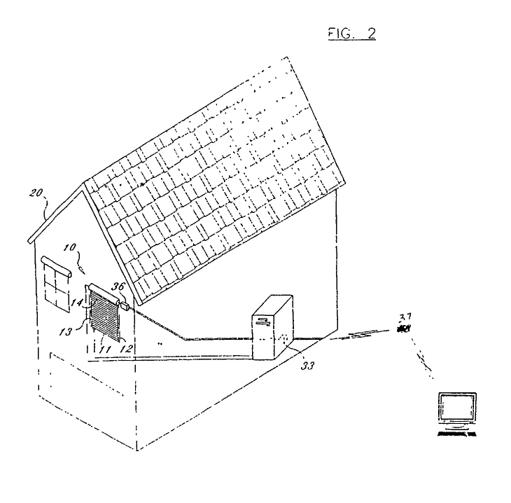

As shown in FIGS. 1-2, the invention includes remote controlled hurricane shutter system 1. System 1 allows a user to deploy hurricane shutter 111 from a remote location to protect house 20 even if the user is not at home.

Shutter system 1 works in conjunction with hurricane shutter system 10. Hurricane shutter system 10 includes roll type hurricane shutter 11. Roll type hurricane shutter 11 can be designed to include the other elements of the remote controlled shutter system 1 or can be retrofitted to existing roll type hurricane shutters. Roll type hurricane shutter 11 covers window 21 when deployed. Hurricane shutter system 10 contains rails 12 and 13. Rails 12 and 13 are parallel to each other and typically run vertically along opposing sides of window 21. Rails 12 and 13 partially cover shutter 11 and help to retain shutter 11 on house 20.

Hurricane shutter 11 can be retracted to allow access to window 21 as shown in FIG. 2. Shutter 11 contains a plurality of hinges 14. Hinges 14 allow shutter 11 to fold. Hinges 14 run perpendicular to rails 12 and 13. This arrangement allows shutter 11 to be rolled into housing 15.

To deploy and retract shutter 11, motor 16 coils shutter 11. Motor 16 is typically electrically powered. By using motor 16, shutter 11 can be quickly and effortlessly deployed and retracted. Hurricane shutter system 10 includes crank 17 to deploy and retract shutter 11 manually. Crank 17 is necessary because electrical service is often interrupted during the hurricanes in which the shutter is designed to be used.

To hurricane shutter system 10, microprocessor 30 is connected by bus 32. Microprocessor 30 can receive and transmit signals 31 to motor 16 over bus 32. By signaling motor 16 through bus 32, motor 16 can be ordered to deploy shutter 11 and retract shutter 11.

Microprocessor 30 is connected to modem 33. Modem 33 in turn is connected to public network 34. Modem 33 allows information from public network 34 to reach microprocessor 30. Modem 33 also allows microprocessor 30 to transmit information over public network 34.

In the preferred embodiment of the invention shown in FIG. 1, public network 34 is telephone network 35. Telephone network 35 carries analog signals. In this embodiment, modem 33 must also include digital-analog converter 36. Digital-analog converter 36 converts analog signals from telephone network 35 to digital signals understandable by microprocessor 30. Digital-analog converter 36 is also able to convert digital signals from microprocessor 30 to analog signals that are transmitted over telephone network 35.

In the preferred embodiment of the invention shown in FIG. 2, public network 34 is Internet 37. Internet 37 is a digital network connecting remotely located users. In the embodiment connected to Internet 37, modem 33 is able to transmit signals across Internet 37 by a suitable protocol such as TCP/IP.

Remote controlled shutter system 1 preferably includes a means for confirming deployment. A means for confirming deployment should be included for situations when a remote user is not present otherwise to confirm deployment during a storm. Verification is important because house 20 may be without electrical power so that the user might mistakenly believe that house 20 is protected even though shutter 11 has not in fact deployed. If the user knows that shutter 11 has not deployed by remote command, the user can return home or contact a neighbor to deploy shutter 11 manually.

While any means for confirming deployment might be used, one preferred embodiment of a means for confirming deployment is battery 41. Battery 41 supplies power to operate microprocessor 30 even when electrical power to house 20 is interrupted. Preferably, battery 41 can also power motor 16.

Another means for confirming deployment is a means for detecting a power disruption. Remote controlled hurricane shutter system 1 preferably includes a means to detect a power interruption. The means to detect a power interruption is connected to microprocessor 30. When the means to detect a power interruption observes an outage, microprocessor 30 signals the user via public network 34 of the electrical power interruption.

Another means for confirming deployment is deploy circuit 42 that is completed when shutter 11 is deployed. Deploy circuit 42 includes two contacts 43 and 44. First contact 43 is located on shutter 11. Second contact 44 is located on window 21 or rail 12 or 13. First contact 43 and second contact 44 are constructed and arranged to complete deploy circuit 42 by touching when shutter 11 is deployed. First contact 43 and second contact 44 are both connected by wire 45 that is also connected to microprocessor 30. Microprocessor 30 includes a means to detect the completion of deploy circuit 42. When deploy circuit 42 is completed, the user is signaled through public network 34 by microprocessor 30 that shutter 11 has been deployed. A similar means for detecting when shutter 11 is retracted can also be included by including third contact 46 that completes retract circuit 47 when shutter 11 has been retracted.

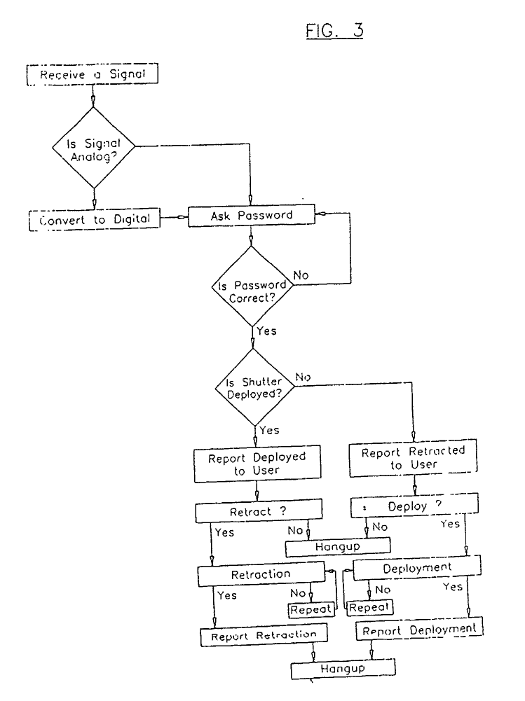

Microprocessor 30 and modem 33 contain software that controls microprocessor 30 and allows a user to control system 1 remotely. FIG. 3 is a flowchart depicting the preferred logic that microprocessor 30 follows. To control system i, a user connects to remote controlled hurricane shutter system 1 from a remote location via public network 34, through modem 33, to microprocessor 30. In the embodiment utilizing telephone network 35, the user uses a telephone or analog modem to dial the phone number of the telephone line to which modem 33 is connected. In an embodiment utilizing Internet 37, a remote terminal is used to access microprocessor 30. Once connected, the user can use the telephone keypad to enter a password that microprocessor reads. If the password is incorrect, the user is asked to reenter the password. If the password is correct, microprocessor 30 can transmit information relating to remote controlled hurricane shutter system 1. Specifically, microprocessor 30 can relay to the user whether shutter 11 is deployed or retracted. Microprocessor 30 also can relay whether electrical power is being supplied to system 1. Next, microprocessor 30 detects if shutter 11 is deployed, if so, the user is asked to retract shutter 11. If microprocessor 30 detects that shutter 11 is retracted, microprocessor 30 can ask for the user to signal to deploy shutter 11. If no change to the position of shutter 11 is to be made, microprocessor 30 can end the call. If the position of shutter 11 is to be changed, microprocessor 30 can detect a change in the position of shutter 11 and then relay a signal to the user that the position of shutter 11 has changed. Once the position of shutter 11 is confirmed, microprocessor 30 can end the call.

The instant invention has been shown and described herein in what is considered to be the most practical and preferred embodiment. It is recognized, however, that departures may be made therefrom within the scope of the invention and that obvious modifications will occur to a person skilled in the art.

I claim:

1. A remote controlled hurricane shutter system connected to a network through which a remote user can control the hurricane shutter system, comprising:
a hurricane shutter system including a roll type hurricane shutter and a motor that deploys and retracts said shutter;
a modem connected to the network so as to receive a signal from the network;
a microprocessor connected to said modem and said hurricane shutter system that deploys said hurricane shutter when the signal is relayed by said modem.

2. The remote controlled hurricane shutter as described in claim 1, further comprising:
a means for confirming deployment connected to said microprocessor and said hurricane shutter system.

3. The remote controlled hurricane shutter as described in claim 2, wherein said means for confirming deployment is a back-up power supply connected to said microprocessor and said motor.

4. The remote controlled hurricane shutter as described in claim 2, wherein said means for confirming deployment is a power supply detector that indicates to the user that said remote controlled hurricane shutter is powered.

5. The remote controlled hurricane shutter as described in claim 2, wherein said means for confirming deployment is a shutter state detector that indicates to said microprocessor that said shutter is deployed.

6. The remote controlled hurricane shutter as described in claim 4, wherein said shutter state detector includes a circuit connected to said microprocessor including a first contact in said shutter and a second contact in the window and said first contact and said second contact are positioned to touch each other when said shutter is deployed so that said circuit is completed when said shutter is deployed.

7. The remote controlled hurricane shutter system as described in claim 1, wherein said network is a telephone line.

8. The remote controlled hurricane shutter system as described in claim 7, wherein said modem contains a digital to analog converter that bi-directionally coverts.

9. The remote controlled hurricane shutter system as described in claim 1, wherein said network is an Internet.
